(19) United States
(12) Patent Application Publication
(10) Pub. No.: US 2004/0237593 A1
(43) Pub. Date: Dec. 2, 2004

(54) Method and device for depositing glass layers on the external surface of a rod-like glass preform

(76) Inventors: Mattheus Jacobus Nicolaas Van Stralen, Tilburg (NL); Martinus Johannus Marinus Joseph Swarts, Veldhoven (NL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/489,434

(22) PCT Filed: Sep. 23, 2002
(86) PCT No.: PCT/NL02/00610

(30) Foreign Application Priority Data
Oct. 1, 2001 (NL) 1019076

(51) Int. Cl. C03B 37/018

(52) U.S. Cl. 65/391

(57) ABSTRACT

A method for depositing one or more glass layers on the external surface of a rod-like glass preform. The method: i) places the preform in an enclosed space, ii) creates a sub-atmospheric pressure in the enclosed space, iii) supplies one or more reactive gases, which may or may not be doped, to the enclosed space, iv) generates a plasma zone in the enclosed space, and v) carries out a deposition reaction.

The present invention relates to a method for depositing one or more glass layers on the external surface of a rod-like glass preform, which method comprises the steps of:

i) placing the preform in an enclosed space,

ii) creating a sub-atmospheric pressure in said enclosed space,

iii) supplying one or more reactive gases, which may or may not be doped, to the enclosed space,

iv) generating a plasma zone in said enclosed space, and

v) carrying out a deposition reaction.

The present invention furthermore relates to a device for depositing one or more glass layers on the external surface of a rod-like glass preform, which device comprises an enclosed space, means for creating a sub-atmospheric pressure, means for supplying one or more reactive gases, which may or may not be doped, means for fixing said preform, means for generating a plasma zone and usual supply and discharge pipes.

British patent application GB 2 149 779 relates to a method for manufacturing optical fibre preforms, in which a so-called perforated inner tube surrounded by a substrate tube is used. A reactive gas mixture is passed through the perforated inner tube, which gas mixture penetrates through the perforations, finding its way into the annular space between the inner tube and the substrate tube, and which subsequently, as a result of the plasma conditions, is deposited on the interior of the substrate tube in the form of glass layers. The plasma is generated from the outside of the substrate tube by means of two microwave generators, which supply energy to so-called microwave cavities formed of an outer cylinder and an inner cylinder.

Such a method is known per se from U.S. Pat. No. 6,138,478. According to the method that is known therefrom, the rod-like preform is placed in an enclosed space, after which a reactive gas is supplied and a plasma zone is developed in the enclosed space. The deposition reaction is carried out in such a manner that a resonator, which generates the plasma zone only locally on the rod-like preform, is reciprocated along the length of the rod-like preform, so that a glass layer is locally deposited on the external surface of the preform with each pass. This manner of plasma generation makes it desirable that a protective gas be supplied to the enclosed space during the deposition reaction in order to prevent glass layers being deposited on the internal wall of the enclosed space as well. A gas consisting of oxygen is supplied as the protective gas, and the pressure of the protective gas being supplied is higher than the pressure of the reactive gas. One drawback of this method is the fact that an electromagnetic field having a maximum field strength on the external surface of the preform is created, whilst said field strength must remain substantially zero in the interior thereof, which imposes limitations as regards the amount of glass material to be deposited on the exterior of the preform. Another drawback is the possible entry of impurities into the enclosed space via the protective gas, which impurities find their way into glass layers deposited on the external surface of the rod-like preform, where they will interfere with the performance of the optical fibres manufactured from the preform.

Consequently it is an object of the present invention to provide a method and a device for depositing one or more glass layers on the external surface of a rod-like glass preform with a high deposition efficiency.

Another object of the present invention is to provide a method and a device for depositing one or more glass layers on the external surface of a rod-like glass preform, in which a very constant thickness and a concentric structure of the glass layers deposited on the external surface of the preform are achieved.

Another object of the present invention is to provide a method and a device for depositing one or more glass layers on the external surface of a rod-like glass preform, in which the refractive index value of the glass layers deposited on the external surface of the preform can be precisely controlled.

Yet another object of the present invention is to provide a method and a device for depositing one or more glass layers on the external surface of a rod-like glass preform, in which it is not necessary to supply a protective gas to the enclosed space.

According to the present invention, the method referred to in the introduction is characterized in that step i) is carried out by fixing the preform between two microwave devices, with the preform functioning as a dielectric guide, which microwave devices are driven in such a manner that one or more glass layers having a concentric layer structure are formed on the external surface of the preform according to step v).

According to the present invention, a rod-like glass preform is thus fixed between two microwave devices, which microwave devices generate a plasma zone. Since the rod-like preform functions as a guide for the microwaves, a thin plasma is formed around the external surface of the preform, the intensity of which is substantially constant along the entire length of the preform. In addition to that, the intensity or penetration depth of the plasma is limited. Because the plasma zone extends over the entire preform, in contrast to the method which is known from U.S. Pat. No. 6,138,478, which employs a plasma zone which constantly moves along the length of the preform, glass layers having a constant thickness and a concentric structure are deposited according to the present invention. The formation of standing waves in the rod-like preform is prevented by using two mutually perpendicular polarization modes or two independent microwave devices. Preferably, the wall of the enclosed space is spaced from the rod-like preform by a distance of at least 10 cm.

It is desirable for the intensity of the plasma generated in step iv) to be substantially constant along the entire length of the preform. In addition, it is preferable in specific embodiments for the two microwave devices to be activated alternately so as to couple microwaves into the preform, which preform functions as a dielectric guide.

It is in particular preferred to carry out the present method in such a manner that the deposition of the glass layers in accordance with step v) takes place while the rod-like preform is being rotated. As a result of the rotation of the rod-like preform, a concentric layer structure is effected on the external surface of the preform.

In specific embodiments it is furthermore desirable to carry out the deposition of the glass layers on the external surface of the preform while rotation of the polarization mode of the microwaves takes place, so as to deposit one or more glass layers having a concentrical layer structure on said external surface of the preform.

In order to have the rod-like preform function as a dielectric guide in the present invention, the diameter of the rod-like preform is preferably in accordance with the following equation:

$$D > \frac{{C}_{0}}{1 \text{,} 706 * f * {n}_{avg}}$$

wherein:

C₀=light velocity (m/s),

n_{avg}=average refractive index, and

f=microwave frequency (s⁻).

A sufficient amount of glass volume, as defined in the above equation, is needed in order to be able to use the rod-like preform as a waveguide. The term average refractive index is to be understood to mean the average refractive index which the microwaves experience in the preform. If the diameter of the preform is smaller than the diameter according to the above formula, microwave guidance is not possible, nor is the formation of plasma without the preform.

The present invention further relates to a device for depositing one or more glass layers on the external surface of a rod-like glass preform, which device is according to the present invention characterized in that the means for generating a plasma zone comprise two microwave devices and in that the rod-like preform is clamped between the two microwave devices at either end, in which the microwave devices comprise means which arrange for the formation of one or more glass layers having a concentric layer structure on the external surface of the preform.

It is in particular desirable for the microwave devices to comprise means which maintain the plasma intensity at a substantially constant value along the entire length of the preform. In addition it is possible for the microwave devices to comprise means which activate the microwave devices alternately for the purpose of coupling the microwaves into the preform, which preform functions as a dielectric guide.

The present invention is furthermore characterized in that the enclosed space comprises means for rotating the preform.

In a special embodiment, the microwave devices preferably comprise means for rotating the polarization mode. Moreover, in order to prevent the formation of standing waves, each microwave device preferably has its own separate energy source. It should be understood that the microwave devices may be disposed either inside or outside the enclosed space, but that each end of the rod-like preform receives microwave radiation.

The present invention will be explained hereinafter by means of an example, it should be noted, however, that the present invention is not restricted to such an example.

### EXAMPLE

A rod-like glass preform having an external diameter of 38 mm is clamped between two microwave devices in an enclosed space. The polarization state of the microwaves in one microwave device extends perpendicularly to the polarisation state of the other microwave device. Both microwave devices are connected to the same energy source, with a frequency of 2.45 GHz being used. Subsequently, a sub-atmospheric pressure of 5-200 mbar is generated in the enclosed space, after which a low-pressure plasma is created around the rod-like preform. A mixture of silicon tetrachloride and oxygen is supplied to the enclosed space, in which a vacuum has thus been generated, in which enclosed space the silicon tetrachloride will react to form silicon dioxide, which compound is deposited on the external surface of the rod-like preform in the form of a glassy material. After a period of 13 hours, the supply of the reactive gas is stopped, the pressure in the enclosed space is increased from said sub-atmospheric pressure to ambient pressure and the rod-like preform thus treated is removed from said space, which rod-like preform appears to have an external diameter of 76 mm, which diameter has been doubled in comparison with the situation before the deposition.

1. A method for depositing one or more glass layers on the external surface of a rod-like glass preform, which method comprises the steps of:
i) placing the preform in an enclosed space,
ii) creating a sub-atmospheric pressure in said enclosed space,
iii) supplying one or more reactive gases, which may or may not be doped, to the enclosed space,
iv) generating a plasma zone in said enclosed space, and
v) carrying out a deposition reaction, characterized in that
step i) is carried out by fixing the preform between two microwave devices, with the preform functioning as a dielectric guide, which microwave devices are driven in such a manner that one or more glass layers having a concentric layer structure are formed on the external surface of the preform according to step v).

2. A method according to claim 1, characterized in that the intensity of the plasma generated in step iv) is substantially constant along the entire length of the preform.

3. A method according to claim 1, characterized in that the two microwave devices are activated alternately so as to couple microwaves into the preform, which preform functions as a dielectric guide.

4. A method according to any one of the preceding claims, characterized in that the deposition of the glass layers in accordance with step v) takes place while the preform is being rotated.

5. A method according to any one or more of the preceding claims, characterized in that the deposition of the glass layers in accordance with step v) is carried out while rotation of the polarization mode of the microwaves takes place.

6. A method according to any one or more of the preceding claims, characterized in that each microwave device is connected to a separate energy source.

7. A method according to any one or more of the preceding claims, characterized in that the diameter of the rod-like glass preform is in accordance with the following equation:
$$D > \frac{{C}_{0}}{1 \text{,} 706 * f * {n}_{avg}}$$
wherein:
C₀=light velocity (m/s),
n_{avg}=average refractive index, and
f=microwave frequency (s⁻¹).

8. A device for depositing one or more glass layers on the external surface of a rod-like glass preform, which device comprises an enclosed space, means for creating a sub-atmospheric pressure, means for supplying one or more reactive gases, which may or may not be doped, means for fixing said preform, means for generating a plasma zone and usual supply and discharge pipes, characterized in that the means for generating a plasma zone comprise two microwave devices and in that the rod-like preform is clamped between the two microwave devices at either end, in which the microwave devices comprise means which arrange for the formation of one or more glass layers having a concentric layer structure on the external surface of the preform.

9. A device according to claim 8, characterized in that the microwave devices comprise means which maintain the plasma intensity at a substantially constant value along the entire length of the preform.

10. A device according to claim 8, characterized in that the microwave devices comprise means which activate the microwave devices alternately for the purpose of coupling the microwaves into the preform, which preform functions as a dielectric guide.

11. A device according to any one or more of the claims 8-10, characterized in that the enclosed space comprises means for rotating the preform.

12. A device according to any one or more of the claims 8-11, characterized in that the microwave devices comprise means for rotating the polarization mode of the microwaves.

13. A device according to any one or more of the preceding claims, characterized in that each microwave device has its own separate energy source.
